(19) United States
(12) Patent Application Publication
(10) Pub. No.: US 2026/0052039 A1
(43) Pub. Date: Feb. 19, 2026

(54) STANDALONE RADIO SYSTEM PATCHING DEVICE

(71) Applicant: Lennard A. Gumaer, Bloomfield Hills, MI (US)

(72) Inventor: Lennard A. Gumaer, Bloomfield Hills, MI (US)

(21) Appl. No.: 19/244,957

(22) Filed: Jun. 20, 2025

Related U.S. Application Data
(60) Provisional application No. 63/662,011, filed on Jun. 20, 2024.

(51) Int. Cl. H04L 12/64

(52) U.S. Cl. CPC H04L 12/6418; H04L 2012/6421

(57) ABSTRACT

A patching device for a radio communication system having a plurality of input and output ports configured to connect various connected devices with the radio communication system. The patching device includes a control circuit configured to receive signaling inputs indicative of transmit and receive states; one or more signal routing components configured to direct audio communications between selected interfaces based on the signaling inputs; and one or more output control components configured to generate signaling outputs to the connected devices. The control circuit is configured to: apply prioritization logic to different types of communication systems; prevent simultaneous activation of conflicting audio paths; and electrically isolate signal paths to reduce risk of feedback or equipment malfunction.

### CROSS-REFERENCE TO RELATED APPLICATION

This application claims the benefit of U.S. Provisional Application Ser. No. 63/662,011, filed Jun. 20, 2024, which is incorporated herein by reference in its entirety.

### TECHNICAL FIELD

The present disclosure relates to methods and systems for a radio communication system, and in particular, to a patching device for patching analog and digital radio resources in public safety communication networks.

### BACKGROUND OF THE INVENTION

First responders and public safety professionals including firefighters, police officers, paramedics, emergency medical technicians and countless others depend heavily upon timely communication from their dispatchers, Command, and amongst each other. The reliability and rapid exchange of voice and other types of electronic communications is vital for saving lives and property.

Public safety radios systems have evolved from simple analog communications to complex digital networks. Around 1990, the P25 radio standard was developed and has evolved into a complex digital and conventional radio communications system used extensively in North America for public safety applications.

Public safety radio systems vary widely in their scope and kind of implementation but all have similar basic components. These components include (1) a dispatch console, (2) a network core, (3) transmission facilities which may include one or more radio tower sites, and (4) the subscriber units, which vary widely and may include handheld portable two-way radios, receive-only voice pagers, in-vehicle mobile two-way radios, or a variety of other transmitting receiving units.

A typical dispatch console includes an audio input, such as a microphone, an audio output, such as speakers or headphones, and a way to visually view and select many different radio channels, talk groups, and other logical groupings of channels, collectively known as resources.

A dispatcher is often seated in front of the console, which may be on a computer screen or other display. This dispatcher uses the console to communicate with public safety personnel in the field, such as personnel on the way to an incident scene, on scene, or returning to quarters. The dispatcher can typically select a specific radio channel to transmit and receive, or can select multiple channels to transmit on at the same time (called Multiselect).

The dispatcher can also group together multiple resources dynamically via a logical construct called a patch. A patch logically connects multiple resources together bidirectionally, so any patch member can hear all other patch members when they transmit, and vice versa.

Patching is an important tool to share communications among different groups of personnel, such as between a police and fire department responding to a motor vehicle accident, or especially in a large-scale incident such as an active shooter or long-term incidents like storms and floods. Patching can also allow agencies from different geographic or jurisdictional areas to share communications.

Several large multinational corporations have developed and provide comprehensive public safety radio systems of varying sizes, including some or all basic components of the system. This allows a customer to purchase a complete system from one source. Contemporary systems rely heavily on a desktop PC and software to produce the console display and user interface at the dispatcher's workstation. This means that software is used to run functions of the system. As with any complex software environment, limitations in capability, either due to intentional design limitations, or functional vulnerabilities arising from incompatibilities and software bugs often appear.

While, some current commercial implementations allow analog resources to be connected to the dispatch console apparatus itself, and other current commercial implementations provide means of connecting analog resources through a gateway or bridge, however, current commercial implementations have software limitations that prevent certain combinations of analog and digital resources from being patched together effectively. These limitations create operational challenges for public safety personnel who need seamless communication across different radio technologies. Commercial vendors cannot envision all possible combinations of resources a public safety agency may require for its operations and lack of flexibility in their systems presents a serious problem for agencies with specific operational communications requirements that cannot be met. For example, because most all commercially available systems allow analog or conventional resources to be manipulated agnostically alongside digital or P25 resources, limitations arising from software issues with the console implementations can be solved by combining channels together outside of the system by use of the system's conventional ports or gateways.

### SUMMARY OF THE INVENTION

The present invention provides a patching device that enables connection of dissimilar radio resources that cannot be patched together using conventional console software. More specifically, the present invention addresses an important limitation, namely inability to patch together dissimilar resources, arising from a monolithic contemporary commercial implementation of the P25 public safety radio system. More specifically, the present invention allows, connection or patching together various resources, including analog resources with digital resources, digital resources with other digital resources, and even analog resources, with other analog resource, and even a combination of the above. The present invention overcomes flexibility limitations in commercially available public radio systems by patching channels and resources together outside of the commercial system. For example, the present invention may allows connection of conventional gateway ports together logically by sensing, receiving, and transmitting signaling protocols, audio frequency signals, and control protocols amongst one or more gateway ports and external radio equipment to achieve patching combinations not supported by commercially available console solutions.

The present invention solves the flexibility limitations of commercially available radios communication systems by patching and connecting channels and resources together external to the radio communications system's existing hardware and software implementation. The patching device includes at least one port, which can be bidirectional, or if the ports are unidirectional at least one input port and one output port. These input and output port(s) may be configured to connect to connected devices, of which one would be the radio communication system. The other connected devices, which are connected through the present invention may include without limitation radio transceiver, a console, a fiber or other media convertor, another communication system, and an analog or digital gateway. The present invention also includes a control circuit configured to receive signaling inputs indicative of transmit and receive states; one or more signal routing components configured to direct audio communications between selected interfaces based on the signaling inputs; and one or more output control components configured to generate signaling outputs to the connected devices. The control circuit is configured to: apply prioritization logic to different types of communication content; prevent simultaneous activation of conflicting audio paths; and electrically isolate signal paths to reduce risk of feedback or equipment malfunction, and limit damage from electrical transients arising from external causes, such as a nearby lightning strike.

The present invention is directed to a patching device for a radio communication system comprises a plurality of input and output ports, wherein at least one of the ports is configured to connect to connected devices of the radio communication system. The patching device includes a control circuit configured to receive signaling inputs from at least one of the plurality of ports, indicative of transmit and receive states. The device has one or more signal routing components configured to direct audio communications between selected ports of the plurality of ports, based on the signaling inputs, and one or more output control components configured to generate signaling outputs to selected ports of the plurality of ports. The control circuit is configured to apply prioritization logic to different types of communication content, prevent simultaneous activation of conflicting audio paths between the plurality of ports, and electrically isolate signal paths between the plurality of ports to reduce risk of feedback or equipment malfunction.

The patching device of the above configuration detects simultaneous tone content and voice content in input signals from the plurality of ports, and the control circuit inhibits the voice signal path while allowing tone signal routing. The control circuit restores a previously inhibited voice signal path after a tone signal is no longer received by at least one of the plurality of ports, without requiring re-assertion of the voice signaling input.

The audio signal path between two of the plurality of ports is established only upon detection of a valid signaling sequence including at least one of a COR assertion or a PTT assertion. The control circuit prevents relay activation that would result in unintended signal reflection, audio feedback, or crosstalk between at least two of the plurality of ports into a transmitting source. The patching device includes a priority override mode in which tone signaling is permitted to preempt any active voice transmission signal.

The patching device further comprises one or more illuminating indicators configured to provide visual feedback corresponding to the signaling inputs. The control circuit is further configured to generate the visual feedback via the illuminating indicators based on detection of the audio signals. The illuminating indicators comprise a multicolor LED display configured to differentiate between voice transmission, tone transmission, and a standby mode. The control circuit is configured to store a log of the received audio signals including a timestamp, a signal source, and the transmission priority.

A method for managing audio signal routing in a radio communication system comprises receiving a plurality of audio signals via a plurality of ports associated with the radio communication system, receiving signaling inputs indicative of transmit and receive states, detecting a received audio signal via one of the plurality of ports, assigning a transmission priority to the received audio signal, routing the received audio signal to a selected port of the radio communication system, and interrupting an incoming audio signal in response to the transmission priority of the incoming audio signal being lower than the transmission priority of the received audio signal. The method further comprises detecting that the received audio signal comprises a paging tone based on a predefined frequency pattern.

The method further comprises illuminating a visual indicator corresponding to the radio ports transmitting the received audio signal, logging a transmission event including the source port of the radio ports, destination port, signal type, and timestamp, and resuming transmission of a previously interrupted audio signal in response to transmission of the received audio signal being complete. The interrupting step includes suppressing voice traffic in response to detecting simultaneous tone and voice signals.

A non-transitory computer-readable medium stores instructions that when executed by a processor of a radio patching device, cause the processor to receive audio signals via a plurality of radio ports associated with respective radio communication systems, detect an audio signal received via one of the radio ports, assign a transmission priority to the detected audio signal, and control an output component to suppress transmission of any other audio signal having a lower transmission priority than the detected audio signal. The instructions further cause the processor to detect the audio signal as a paging tone based on a predefined frequency range, tone duration, or signal pattern, activate one or more illuminating indicators corresponding to the radio port actively transmitting the detected audio signal, and log each routing event including a timestamp, source port identifier, destination port identifier, and assigned priority level.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1 illustrates the input side of a patching device, including its port layout and labeling, according to the present disclosure.

FIG. 2 illustrates a front-top perspective view of the patching device, showing the enclosure and visual indicators, according to the present disclosure.

FIG. 3 illustrates a schematic view of a dispatch console screen in communication with the patching device, according to the patching device, according to the present disclosure.

FIG. 4 illustrates a schematic diagram of a public safety communication system incorporating the patching device, according to the present disclosure.

FIG. 5 illustrates a functional block diagram of the internal components of the patching device, according to the present disclosure.

### DETAILED DESCRIPTION OF PREFERRED EMBODIMENTS

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

The present disclosure describes a patching device capable of a communications patching solution. While the patching device is typically implemented as a standalone device that connects via cables to analog or conventional gateway of a public safety radio system or bridge ports, the patching device may also be incorporated as a component or sub-system within a larger radio system. The patching device facilitates signal routing between gateway ports in a manner not supported by conventional dispatch console software, thereby enhancing system flexibility and reliability.

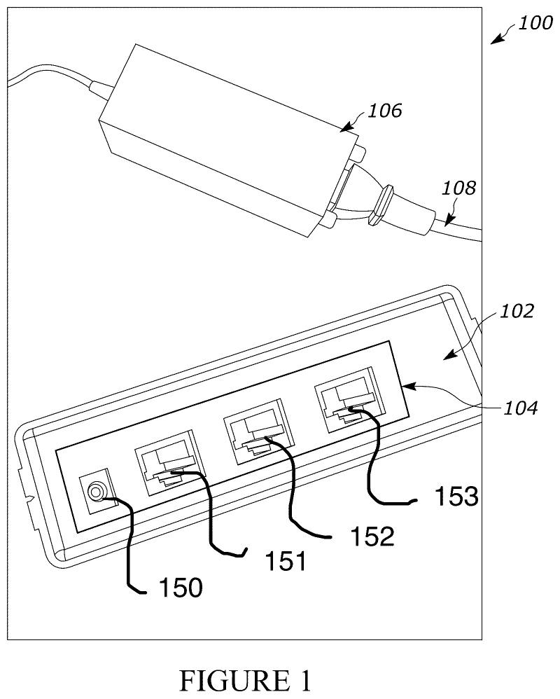

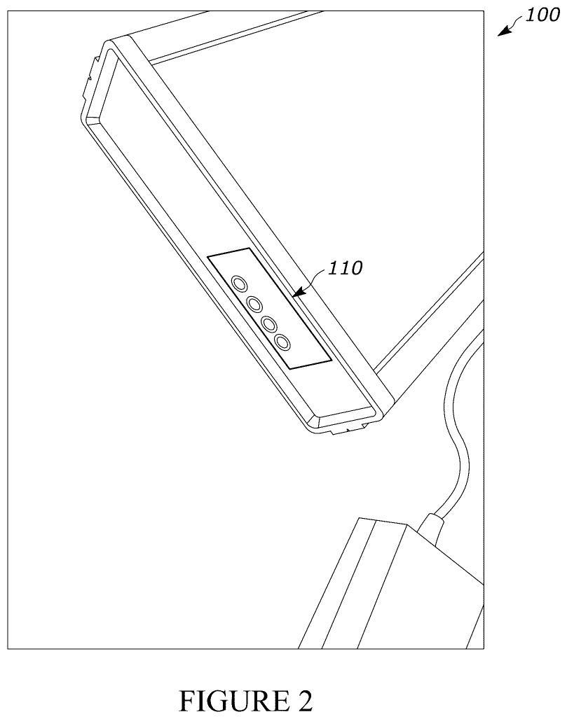

FIGS. 1 and 2 illustrates an exemplary implementation of a patching device 100. The patching device 100 includes an enclosure 102 housing a circuit board (not depicted) with the necessary signal-processing components, input/output connectors, and visual status indicators 110. The patching device typically includes multiple ports 104 for interfacing with commercial radio system components and is configured to carry signals such as push-to-talk (PTT), carrier-operated relay (COR), and transmit (TX) audio, and receive (RX) audio.

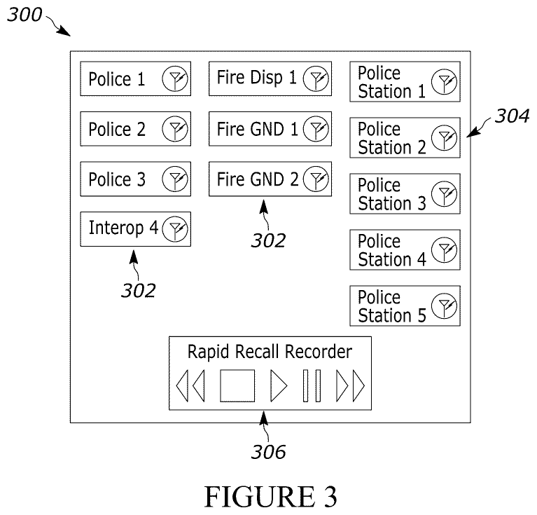

The patching device 100 may be powered by either an internal AC-powered supply or an external power supply 106 connected via a multi-conductor cord 108. Depending on the hardware configuration and any onboard microprocessor programming, the patching device 100 routes audio between ports 104 based on timing and received signaling inputs, including PTT and COR signals. The patching device 100 facilitates routing and patching configurations between radio system resources in ways that are not supported by standard console software systems as shown in FIG. 3.

In some embodiments, the patching device 100 includes, but is not limited to, an internal AC-to-DC power supply unit or a redundant pair of internal AC-to-DC power supply units, or any combination of internal and external power supply units. Power supply units can be of the switch-mode or linear type.

The patching device 100 is configured to be reliable and simple, offering resilience against software crashes, PC failures, and vulnerabilities common to modern console-based solutions. The hardware based architecture makes it resistant to bugs, hacking attempts, or other software-related interruptions.

In some embodiments, the patching device 100 contains safety mechanisms to protect externally connected equipment. External contact-closure signaling (commonly referred to as PTT, COR, or E&M) is galvanically isolated from the internal circuitry of the patching device 100. The excitation voltage and current used to interface to the PTT and COR terminals of the externally connected equipment is limited to a very low level. This protects the externally connected equipment against damage from transients, ground loops, and short circuits arising from malfunctions or cabling damage.

In some embodiments, relay and/or switching devices in signaling paths are solid state so they are not subject to mechanically aging, wearing out, or similar operational malfunction.

Mechanical relays are used in the audio path to provide a nearly zero-leakage open circuit when a relay contact is open or disabled. Relays are typically configured in a manner to prevent crosstalk or feedback in an arrangement referred to as cross muting. This allows audio signal paths to come from one or more sources and transit to one or more receivers without being inadvertently fed back to the source or sources. Cross muting is a requirement when interfacing communications equipment that is capable of full-duplex operation wherein it can simultaneously transmit and receive over the same or parallel separate channels.

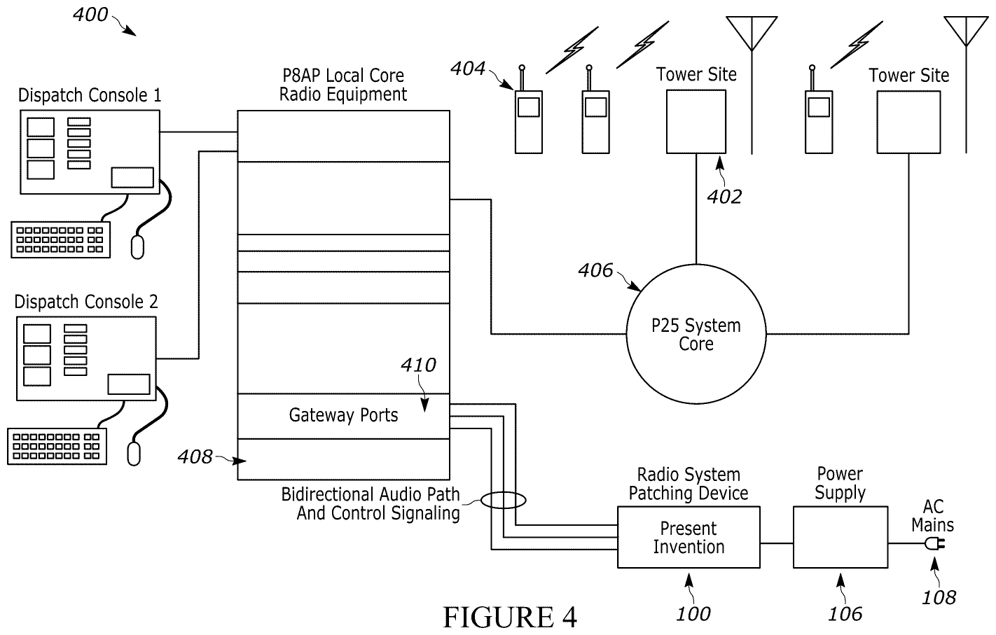

The patching device 100 typically connects to conventional channel ports or gateway channels 408 provided by the local radio system core 410, as illustrated in FIG. 4.

FIG. 3 is an exemplary typical public safety dispatch console screen 300 on the dispatch console 412, depicting radio channel resources 302 for police and fire, pager buttons 304 for fire station paging, and a rapid recall recorder window 306.

FIG. 4 is an exemplary simplified public radio system 400 typical of the APCO P25 type commonly used in the United States. Dispatch consoles 300 of FIG. 3 are in communication with the local system core 406 at the Public Safety Answering Point (PSAP), which in turn is in communication with the P25 system core which typically includes one or more remote tower sites 402 and some quantity of handheld portable radio subscriber units 404 and mobile radio subscriber units installed in vehicles and apparatus such as fire trucks.

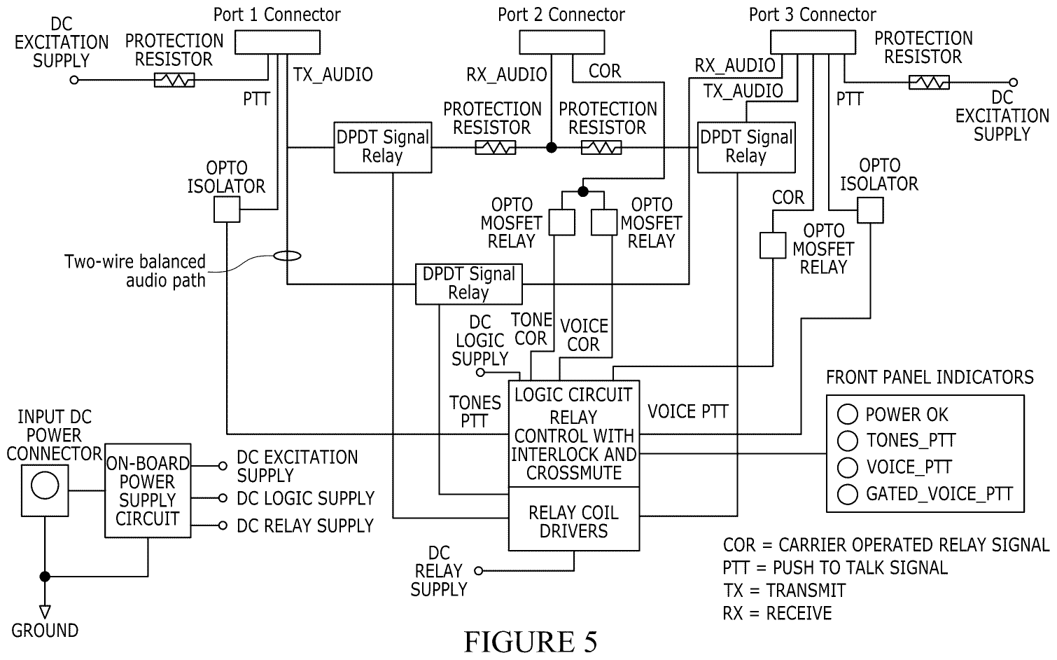

FIG. 5 is an exemplary block diagram of an implementation of the patching device 100 and depicts various sub-components discussed further below. The patching device 100 of FIGS. 1 and 5 connects to the local system core of FIG. 4.

External Patch Device 100 Port Description: Port_1 (FIG. 1 CV1) P25_TONES or CONV_TONES; Port_2 (FIG. 1 CV2) P25_TDMA_PAGE or RADIO; Port_3 (FIG. 1 CV3) P25_DISPATCH; Power (FIG. 1+12V)+12V DC regulated center positive 2.5 mm pin barrel connector.

In some embodiments, alternate port 104 uses apply when the patching device 100 is used in existing scenarios where a gateway port 410 drives a radio transceiver 402 (such as a fire base or RF link control station), and it is desired to patch tones to P25 and to patch P25 dispatch talk group to the radio for situational awareness from conventional analog pagers.

In some embodiments, the patching device 100 may also be configured with additional ports 104 to provide parallel redundancy, allowing the connection of duplicate radio equipment to the ports 104 to protect against a single failure in a piece of equipment connected thereto.

The patching device 100 has several illuminating indicators 110 on its front panel to indicate the current operational state of the patching device 100. The exemplary implementation of the patching device 100 as depicted in FIG. 2 has the following indicators: POWER (PWR) (illuminates green); TONES_PTT (TPTT) (illuminates red); VOICE_PTT (VPTT) (illuminated yellow); and GATED_VOICE_PTT (GVP) (illuminates orange).

The input/output ports, depicted as CV1, CV2, and CV3 in FIG. 2, and Port1, Port2, and Port3 in FIG. 1, accept hardwired signaling known in the industry as “E&M”, or literally, cars and mouth. The terminology means that one DC circuit closure contact indicates a desire to transmit (mouth) or a desire to receive (car).

In the exemplary implementation of the patching device 100 depicted in FIGS. 1, 2, and 5, all of the ports either accept or send E&M type signaling. The signaling extended implementations of the patching device 100 with additional ports which may only send, only receive, or may not have any signaling capability. The exemplary implementation supports the following input signaling: CONV_TONES Port (CV1) TONES_PTT; P25_DISPATCH Port (CV3) VOICE_PTT.

The exemplary implementation supports the following output signaling: P25_TDMA_PAGE Port (CV2) TONE_COR (via an electrically paralleled optical MOSFET relay); VOICE_COR (via an electrically paralleled optical MOSFET relay); and P25_DISPATCH Port (CV3) TONEBACK_COR (via a single optical MOSFET relay).

The Logic Circuit governs operation of the patching device 100 and its operating behavior. It accepts buffered signaling inputs from the input/output ports and produces the appropriate output signals to control the signal routing relays and the PTT and COR signaling relays. The logic circuit in the exemplary implementation produces the following signals: TONE_COR_RELAY drive; TONEBACK_RELAY drive; TONEBACK_COR_RELAY drive; TONE_BUS_RELAY drive; VOICE_BUS_RELAY drive; and VOICE_COR_RELAY drive.

The exemplary implementation of the patching device 100 provides protection against several hazards that could result in communications disruption if certain audio paths were to be inadvertently combined electrically. Typical results of such an inadvertent combination could be distortion, echo, one talking party speaking over top of another, and similar types of conflicts.

The patching device 100 includes logic circuitry to govern the behavior of the patching device 100 dependent upon various input signals presented to its input connectors. For clarity, several abbreviations are used in the associated figures and discussion, they are identified below:

COR-Means Carrier Operated Relay, referring to a signal produced by a radio device upon receiving an active transmission over the air with an RF carrier present. COR is typically asserted by the receiving device regardless of whether there is an audible analog or digital signal modulating the carrier. Some contemporary commercially available P25 implementations may also provide a “talkgroup active” or “channel active” signal which is similar in function to COR but is only present when there is audible audio available. Due to encryption, access controls or other signal processing which may be occurring, a carrier may be present but no audible audio payload is available, and this the “talkgroup active” or “channel active” signal would not be asserted, but the traditional COR signal may be present at such times.

PTT-Means Push To Talk, referring to the pushbutton on a microphone when a human or machine intends to begin transmission over a radio channel. PTT is asserted by the transmitting party for the duration of the transmission. Often used along with COR above to interconnect various types of radio equipment to allow bi-directional transmit and receive signaling.

The patching device 100 implements three basic operating states. During operation, a cross-mute occurs where if tones are going out, the voice audio coming from the P25_DISPATCH port is electrically disconnected from the P25_TDMA_PAGE port, preventing feedback through the TONEBACK_RELAY.

The tones and voice connections to the P25_TDMA_PAGE port's RX pair are electrically isolated by two relays, and logic prevents both relays from being energized simultaneously. TONES_PTT will has priority and will force open the VOICE_BUS_RELAY. This effectively implements a priority cross-mute that prioritizes tones over voice.

State 1 means no paging tones and no P25_DISPATCH voice traffic (no Dispatch voice or field voice chatter): ALL RELAYS OPEN. State 2: TONEOUT STATE. State 2 is initiated by TONES_PTT logical signal going high (active): TONE_BUS_RELAY closed (feeds tones from CONV_TONES port to P25_TDMA_PAGE); TONE_COR_RELAY closed (tells P25_TDMA_PAGE port we have tones coming); TONEBACK_RELAY closed (feeds tones audio to P25_DISPATCH port RX pair); TONEBACK_COR_RELAY (tells P25_DISPATCH port we have toneback coming); and All VOICE relays are inhibited. This prevents chatter on the P25_DISPATCH talkgroup from interrupting tones, and prevents possible feedback in event of BUS relays sticking.

State 3: VOICE TRAFFIC STATE. State 3 is initiated by VOICE_PTT logical signal going high (active): VOICE_BUS_RELAY closed; VOICE_COR_RELAY closed; and All TONE relays open. If a tone out occurs at any time during active voice traffic, all voice relays will open and become inhibited for duration of TONES_PTT logical signal.

The exemplary implementation of the patching device 100 utilizes several approaches to minimize electrical interference and electrical noise effects on the signals passing through the patching device 100, including ensuring no audio signal connections are left in an electrically undefined or floating state.

Both the TONE_BUS_RELAY and the VOICE_BUS_RELAY are DPDT relays and maintain the differential mode of the audio transmission pairs. When either relay is “open”, the relay Normally Closed contacts bridge the pair with a protection resistor. When both relays are “open”, the input RX pair on the P25_TDMA_PAGE port sees a high impedance short (the two protection resistors are effectively in parallel), and will be silent. If only one relay is “open” and the other is “closed”, the bridged protection resistor parasitic load is negligible.

Similarly, the TONEBACK_RELAY in its “open” Normally Closed state presents a protection resistor across the P25_DISPATCH port's input RX pair, keeping things electrically silent. On the P25_TONES port, the input RX pair is permanently bridged with a protection resistor to keep things quiet.

The patching device 100 has several designed-in protective features to protect the circuitry within the patching device 100 as well as the external gateway device it may be connected to.

External PTT excitation current is limited to 120 mA. The DC excitation voltage supplied to the external gateway ports to query their PTT state (by their contact closure) is current-limited to 120 mA by a wire-wound resistor on the patching device 100 circuit board. This also protects the circuit board and power supply 106 from short circuit events should someone cross-cut a port cable with wire cutters, such as when crimping a new modular connector without first unplugging the cable.

Cross-port inadvertent push-pull sum protection is provided by a pair of protection resistors on the output of the TONE_BUS_RELAY and the VOICE_BUS_RELAY. In the event of relay contacts sticking or a logic failure causing both relays to be energized simultaneously, the externally connected gateway ports will be directly paralleled through the protection resistors rather than being directly bridged, avoiding a possible high-load condition on the external gateway port output amplifier stage in the extreme case of worst-case differential voltages between two supplying external gateway ports.

The external gateway port PTT contact closures merely drive an LED within a MOSFET solid state relay which is optically isolated from the patching device 100 circuitry and ground. Similarly, the COR relay closures provided on the patching device 100 circuit board are provided by MOSFET solid state relays which are optically isolated from their driving circuitry and ground.

In order to avoid potential feedback to the P25_VOICE port from existing chatter occurring on the P25 talkgroup console-patched to the external gateway port (presuming full-duplex operation), logic on the patching device 100 circuit board prevents the TONE_BUS_RELAY and VOICE_BUS_RELAY from being energized simultaneously. TONE_PTT always has priority and will force the VOICE_BUS_RELAY to open if VOICE_PTT is active and TONE_PTT becomes active. Upon deactivation of TONE_PTT, the existing VOICE_PTT state is restored. During TONE_PTT active, VOICE_PTT is ignored by the logic.

The patching device 100 is to be powered by an external 12V DC regulated power supply 106 with a 2.5 mm barrel plug 108. The particular power supply 106 chosen is type-selected for medical and mission-critical applications and has very low leakage current. In addition, the external power supply 106 must have no minimum load requirement and will not self-oscillate if open circuit (no load). The external regulated power supply 106 can be either a switch-mode design or a linear design.

In some embodiments, received radio traffic asserted by RADIO_COR has priority over outgoing tones from PAGE resource, in the event full-duplex operation by radio occurs. Could prevent unmonitored transmission of tones blocking reception of ongoing voice conversation on radio.

In some embodiments, PTT closure on PORT_1 and PORT_2 drive separate but paralleled SPST mechanical relays. Mechanical relays chosen because of concerns about ESD/lightning discharge damaging solid state relays. Two relays are used to prevent a single-patching device 100 relay failure from preventing transmission by both PORT_1 and PORT_2 resources.

In some embodiments, PTT closures from CCGW drive optoisolators separately, to prevent unusual current loops and issues with solid-state switching/open-collector/unknown port architecture in CCGW. COR closures to CCGW are driven by solid-state relay to reduce mechanical relay count and improve reliability.

Many modifications and variations of the patching device 100 are possible in light of the above teachings. It is contemplated that all features of all claims and of all embodiments can be combined with each other, so long as such combinations would not contradict one another. It is, therefore, to be understood that within the scope of the appended claims, the disclosure may be practiced otherwise than as specifically described.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. These memory devices may be non-transitory computer-readable storage mediums for storing computer-executable instructions which, when executed by one or more processors described herein, can cause the one or more processors to perform the techniques described herein. The processor and the memory can be supplemented by, or incorporated in, special purpose logic circuitry.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A patching device in communication with a radio communication system, said patching device comprising:
a plurality of ports, wherein at least one of said ports is configured to connect to with the radio communication system;
a control circuit configured to receive signaling inputs from at least one of said plurality of ports, indicative of transmit and receive states;
one or more signal routing components configured to direct audio communications between selected ports of said plurality of ports, based on the signaling inputs; and
one or more output control components configured to generate signaling outputs to selected ports of said plurality of ports,
wherein the control circuit is configured to:
(a) apply prioritization logic to different types of communication content;
(b) prevent simultaneous activation of conflicting audio paths between said plurality of ports; and
(c) electrically isolate signal paths, between said plurality of ports, to reduce risk of feedback or equipment malfunction.

2. The patching device of claim 1, wherein the control circuit detects simultaneous tone content and voice content, in said input signals from the plurality of ports, and wherein the control circuit inhibits the voice signal while allowing the tone signal to be in communication with at least one of said plurality of ports.

3. The patching device of claim 1, wherein the control circuit restores communication with at least one of said plurality of ports of a previously inhibited voice signal after a tone signal is no longer received by at least one of said plurality of ports, without requiring re-assertion of the voice signaling input.

4. The patching device of claim 1, wherein the audio signal path between two of said plurality of ports is established only upon detection of a valid signaling sequence including at least one of a COR assertion or a PTT assertion.

5. The patching device of claim 1, wherein the control circuit prevents relay activation that would result in unintended signal reflection, audio feedback, or crosstalk between at least two of said plurality of ports.

6. The patching device of claim 1, wherein the patching device includes a priority override mode in which the tone signal preempts any active voice signal.7. The patching device of claim 1, wherein the patching device further comprises one or more illuminating indicators configured to provide visual feedback corresponding to the signaling inputs.

7. The patching device of claim 2, wherein the control circuit further configured to generate the visual feedback via the illuminating indicators based on detection of the audio signals.

8. The patching device of claim 7, wherein the illuminating indicators comprise a multicolor LED display configured to differentiate between voice transmission, tone transmission, and a standby mode.

9. The patching device of claim 1, wherein the control circuit is configured to store a log of the received audio signals including a timestamp, a signal source, and the transmission priority.

10. A method for managing audio signal routing for a radio communication system, comprising:
receiving a plurality of audio signals via a plurality of ports associated with the radio communication system detecting by a control;
detecting, by a control circuit, a received audio signal via one of the plurality of ports;
assigning, by the control circuit, a transmission priority to the received audio signal;
routing, by a signal routing component, the received audio signal to a selected port of the radio communication system;
interrupting, by an output control component, an incoming audio signal in response to the transmission priority of the incoming audio signal being lower than the transmission priority of the received audio signal.

11. The method of claim 10, further comprising detecting that the received audio signal comprises a paging tone based on a predefined frequency pattern.

12. The method of claim 10, further comprising illuminating a visual indicator corresponding to the radio ports transmitting the received audio signal.

13. The method of claim 10, further comprising logging a transmission event including the source port of the radio ports, destination port, signal type, and timestamp.

14. The method of claim 10, further comprising resuming transmission of a previously interrupted audio signal in response to transmission of the received audio signal being complete.

15. The method of claim 10, wherein the interrupting step includes suppressing voice traffic in response to detecting simultaneous tone and voice signals.

16. The method of claim 10, further comprising logging a transmission event including the source port of the radio ports, destination port, signal type, and timestamp.

17. The method of claim 10, further comprising resuming transmission of a previously interrupted audio signal in response to transmission of the received audio signal being complete.

18. The method of claim 10, wherein the interrupting step includes suppressing voice traffic in response to detecting simultaneous tone and voice signals.

19. A non-transitory computer-readable medium storing instructions that when executed by a processor of a radio pathing device, cause the processor to: receive audio signals via a plurality of radio ports associated with respective radio communication systems;
detect an audio signal received via one of the radio ports;
assign a transmission priority to the detected audio signal; and
control an output component to suppress transmission of any other audio signal having a lower transmission priority than the detected audio signal.

20. The non-transitory computer-readable medium of claim 19, wherein the instructions further cause the processor to detect the audio signal as a paging tone based on a predefined frequency range, tone duration, or signal pattern.

21. The non-transitory computer-readable medium of claim 19, wherein the instructions further cause the processor to activate one or more illuminating indicators corresponding to the radio port actively transmitting the detected audio signal.

22. The non-transitory computer-readable medium of claim 19, wherein the instructions further cause the processor to log each routing event including a timestamp, source port identifier, destination port identifier, and assigned priority level.
